(19) United States
(12) Patent Application Publication
(10) Pub. No.: US 2009/0218421 A1
(43) Pub. Date: Sep. 3, 2009

(54) COMBUSTOR FUEL NOZZLE CONSTRUCTION

(75) Inventor: Balachandran Kumaravelu, Bangalore (IN)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 12/038,869

(22) Filed: Feb. 28, 2008

(51) Int. Cl. B05B 15/06

(52) U.S. Cl. 239/588; 60/740

(57) ABSTRACT

Disclosed is a fuel nozzle for a combustor which includes a tip section and a tube section. The tube section, in which a first end is connected to the tip section includes an outer tube having a tube axis and connected to the tip section and an inner tube disposed at least partially inside of the outer tube and connected to the tip section. The inner tube includes at least one flexible portion capable of reducing stresses in the fuel nozzle. Also disclosed is a fuel nozzle which includes a tip section, a base section, and a tube section disposed between the tip section and the base section and connected to the tip section at a first end and connected to the base section at a second end. The tube section includes an outer tube having a tube axis and an inner tube disposed at least partially inside of the outer tube and connected to the tip section. At least one rib is disposed on the outer tube and extends radially outwardly from an outer surface of the outer tube.

### BACKGROUND

The subject invention relates to combustors. More particularly, the subject invention relates to oil tubes and water tubes of combustor fuel nozzles.

A combustor of a gas turbine typically includes one or more fuel nozzles to which fuel is delivered and from which fuel is injected into a combustion area of the combustor. Water and fuel are often injected into the combustion zone from a water tube and an oil tube, respectively. In many configurations of nozzles, the oil tube is located inside the water tube, and both the water tube and oil tube are connected to a tip. Combustion dynamics and differential thermal loading between the oil tube and water tube results in eccentricity between the oil tube and water tube during combustor operation. Further, the oil tube is often affected by vibratory frequencies during combustor operation, resulting in high vibratory stresses on the oil tube which increases wear of the oil tube and reduces its useful life.

### BRIEF DESCRIPTION OF THE INVENTION

A fuel nozzle for a combustor includes a tip section and a tube section. The tube section, in which a first end is connected to the tip section includes an outer tube having a tube axis and connected to the tip section and an inner tube disposed at least partially inside of the outer tube and connected to the tip section. The inner tube includes at least one flexible portion capable of reducing stresses in the fuel nozzle.

A second embodiment of a fuel nozzle includes a tip section, a base section, and a tube section disposed between the tip section and the base section and connected to the tip section at a first end and connected to the base section at a second end. The tube section includes an outer tube having a tube axis and an inner tube disposed at least partially inside of the outer tube and connected to the tip section. At least one rib is disposed on the outer tube and extends radially outwardly from an outer surface of the outer tube.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a side view of an embodiment of a fuel nozzle for a combustor;

FIG. 2 is a cross-sectional view of the fuel nozzle of FIG. 1;

FIG. 3 is a partial cross-sectional view of the fuel nozzle of FIG. 1 including a bellows;

FIG. 4 is a partial cross-sectional view of a tip section of the fuel nozzle of FIG. 1; and

FIG. 5 is a partial cross-sectional view of the fuel nozzle of FIG. 1 including a plurality of ribs.

The detailed description explains embodiments of the invention, together with advantages and features, by way of example with reference to the drawings.

### DETAILED DESCRIPTION OF THE INVENTION

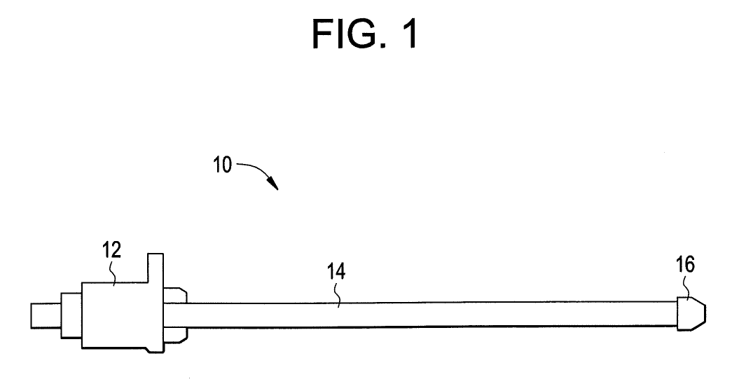

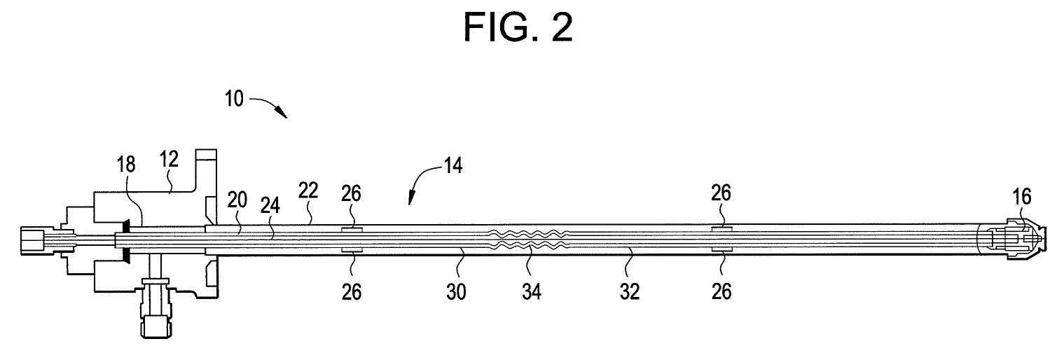

Shown in FIG. 1 is an embodiment of an improved fuel nozzle 10. The fuel nozzle 10 includes a base 12 and a tube section 14 extending from the base 12 to a tip 16. As shown in FIG. 2, in some embodiments, the base 12 includes a bore 18 through which the tube section 14 is inserted and connected to a fuel source (not shown) to provide fuel to the tube section 14. The tube section 14 comprises an oil tube 20 disposed in a water tube 22. In the embodiment shown in FIG. 2, the oil tube 20 and the water tube 22 each have circular cross sections, but other cross sections, including oval, which may be utilized depending on operational requirements of the combustor are contemplated within the scope of the current disclosure. In some embodiments, the oil tube 20 is concentric with the water tube 22 around a tube axis 24. The tube section may further include one or more spacers 26 to maintain the oil tube 20 in a desired radial position, concentric or not, relative to the water tube 22. The spacers 26 may be fully annular in cross section as in the embodiment of FIG. 2, or alternatively may constructed of segments placed between the oil tube 20 and water tube 22 and may be configured with through holes (not shown) or other means to allow a flow of water in the water tube 22 to flow from a first side of the spacer 26 to a second side of the spacer 26. The spacers 26 may be connected to either or both of the oil tube 20 and water tube 22 by, for example, brazing.

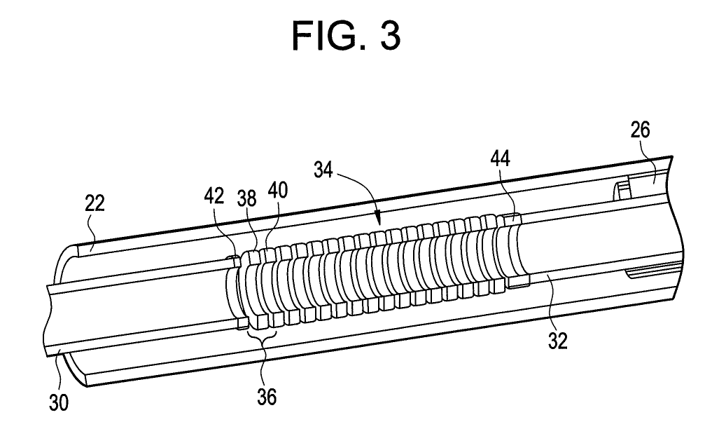

As shown in FIG. 3, the oil tube 20 includes at least a first oil tube portion 30 and a second oil tube portion 32 connected by a least one flexible portion, in this embodiment a bellows 34. The bellows 34 comprises one or more convolutions 36 having an outer diameter 38 and an inner diameter 40 and is connected to the first oil tube portion 30 at a first end 42 and to the second oil tube portion 32 at a second end 44. The bellows 34 may be connected to the first oil tube portion 30 and the second oil tube portion 32 by, for example, brazing, or in some embodiments may be integrally formed with either or both of the first oil tube portion 30 and the second oil tube portion 32. Though the embodiment shown in FIG. 3 includes an oil tube 20 having a single bellows 34, other quantities of bellows 34, for example two or three bellows 34, are contemplated within the scope of the present disclosure.

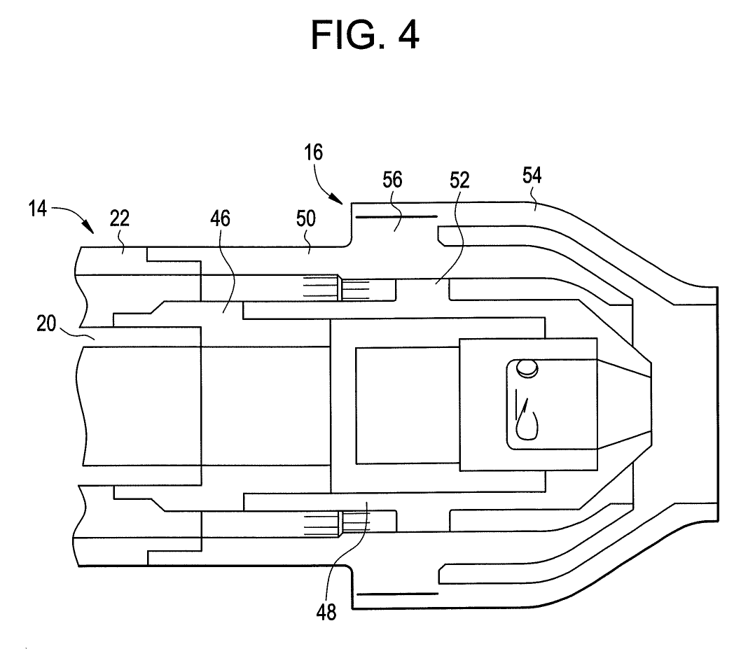

As shown in FIG. 4, the tip 16 is connected to one end of the tube section 14 and may include an annular tube adapter 46 which is concentric with the oil tube 20 and connects the oil tube 20 to a liquid fuel swirler 48. The connections between the oil tube 20 and tube adapter 46 and the tube adapter 46 and liquid fuel swirler 48 may be accomplished by brazing. Concentric with the liquid fuel swirler 48 is an air-fuel swirler 50 which is connected to the water tube 22 at one end and connected to the liquid fuel swirler 48 at a swirler land 52. Finally, a shroud 54 may be included which is disposed radially outboard from the air-fuel swirler 48 and attached thereto at a nozzle land 56 by, for example, brazing. The bellows 34 allow the oil tube 20 to thermally expand and contract relative to the water tube 22 and the tip 16 during operation of the combustor, thereby reducing stresses between the oil tube 20, water tube 22 and tip 16 and extending the useful life of the nozzle 10.

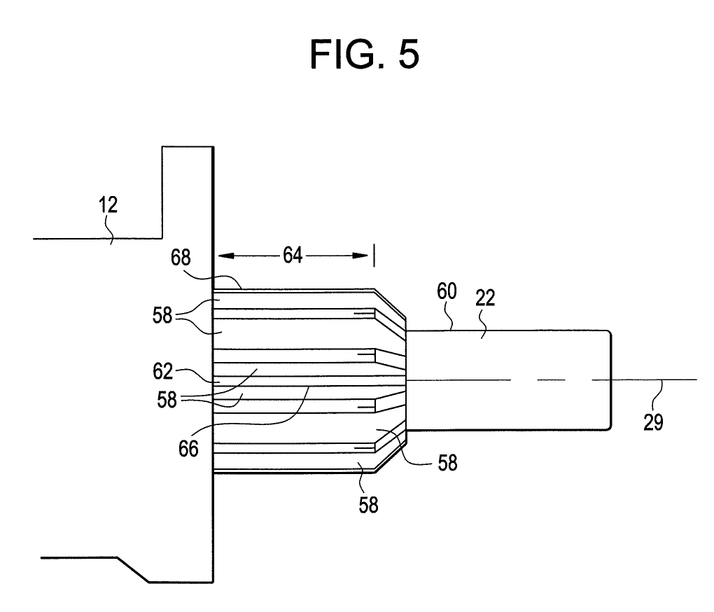

As shown in FIG. 5, in some embodiments, the water tube 22 includes a plurality of ribs 58 extending outwardly from an outer surface 60 of the water tube 22. The ribs 58 are configured and located to shift a natural frequency of the water tube 22 away from a vibratory frequency of the combustor, which in some embodiments is about 350 Hz. The ribs 58 shown In FIG. 5 are located at a base end 62 of the water tube 22. The ribs 58 of this embodiment are aligned substantially along the tube axis 24 and extend substantially radially from the outer surface 60 of the water tube 22. Further, the ribs 58 shown in FIG. 5 are tapered such that an axial length 64 of the ribs 58 is greater at a rib base 66 than an axial length 64 at a rib tip 68. The rib 58 location, arrangement, and configuration shown in FIG. 5 is merely exemplary and other locations, arrangements, and configurations of ribs 58 to shift the natural frequency of the water tube 22 are contemplated within the scope of the current disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel nozzle for a combustor comprising:
a tip section; and
a tube section having a first end connected to the tip section, the tube section including:
an outer tube having a tube axis and connected to the tip section;
an inner tube disposed at least partially inside of the outer tube and connected to the tip section, the inner tube having at least one flexible portion for reducing stresses in the fuel nozzle.

2. The fuel nozzle of claim 1 wherein the outer tube is a water tube and the inner tube is an oil tube.

3. The fuel nozzle of claim 1 wherein the at least one flexible portion comprises a bellows.

4. The fuel nozzle of claim 1 wherein the at least one flexible portion is connected at each end to an inner tube portion.

5. The fuel nozzle of claim 4 wherein the at least one flexible portion is connected to the inner tube portion by brazing.

6. The fuel nozzle of claim 1 wherein the outer tube includes at least one rib extending radially outwardly from an outer surface of the outer tube.

7. The fuel nozzle of claim 6 wherein the at least one rib is capable of shifting a natural frequency of the tube section.

8. The fuel nozzle of claim 6 wherein the at least one rib is substantially parallel to the tube axis.

9. The fuel nozzle of claim 6 wherein the at least one rib is tapered in an axial direction from a rib base to a rib tip.

10. The fuel nozzle of claim 6 wherein the at least one rib is disposed at a base end of the outer tube.

11. The fuel nozzle of claim 1 wherein the outer tube is concentric with the inner tube about the tube axis.

12. A fuel nozzle for a combustor comprising:
a tip section;
a base section; and
a tube section disposed between the tip section and the base section and connected to the tip section at a first end and connected to the base section at a second end, the tube section including:
an outer tube having a tube axis;
an inner tube disposed at least partially inside of the outer tube and connected to the tip section; and
at least one rib disposed in operable communication with the outer tube, the at least one rib extending radially outwardly from an outer surface of the outer tube.

13. The fuel nozzle of claim 12 wherein the at least one rib is capable of shifting a natural frequency of the tube section.

14. The fuel nozzle of claim 12 wherein the at least one rib is substantially parallel to the tube axis.

15. The fuel nozzle of claim 12 wherein the at least one rib is tapered in an axial direction from a rib base to a rib tip.

16. The fuel nozzle of claim 12 wherein the at least one rib is disposed at a base end of the outer tube.

17. The fuel nozzle of claim 12 wherein the outer tube is concentric with the inner tube about the tube axis.

18. The fuel nozzle of claim 12 wherein the outer tube is a water tube and the inner tube is an oil tube.
